(19) United States
(12) Patent Application Publication
(10) Pub. No.: US 2010/0169545 A1
(43) Pub. Date: Jul. 1, 2010

(54) HOST SYSTEM AND OPERATING METHOD THEREOF

(76) Inventor: Lian-Chun Lee, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/368,981

(22) Filed: Feb. 10, 2009

(30) Foreign Application Priority Data
Dec. 25, 2008 (TW) 097150624

(51) Int. Cl. G06F 12/02; G06F 15/177; G06F 12/08; G06F 13/00

(52) U.S. Cl. 711/103; 713/2; 711/114; 710/104; 711/E12.008; 711/E12.019

(57) ABSTRACT

The prevent invention provides a host system and an operating method thereof. The host system comprises: a peripheral device control circuit, for controlling operation of at least a peripheral device, the peripheral device comprising an embedded micro processor; and a host control circuit, coupled to the peripheral device control circuit via a transmission interface, the host control circuit comprising: a storage module, at least storing a firmware of the embedded micro processor; and a control module, coupled to the storage module, for controlling operation of the host control circuit, and the control module transmitting the firmware to the peripheral device control circuit via the transmission interface. The embedded micro processor executes the firmware provided by the host control circuit to control operation of the peripheral device control circuit.

### BACKGROUND OF THE INVENTION

1. Field of the Invention

The present invention relates to a host system and an operating method thereof, and more particularly, to a host system capable of storing a firmware of an embedded micro processor of a peripheral device control circuit of the host system without using electrically erasable programmable read only memory (EEPROM) and an operating method thereof.

2. Description of the Prior Art

Please refer to FIG. 1. FIG. 1 shows a simplified block diagram of a conventional host system 100. As shown in FIG. 2, the host system 100 comprises: a peripheral device control circuit 110, a host control circuit 120, a peripheral device 130, a transmission interface 140, a motherboard 150, and an electrically erasable programmable read only memory (EEPROM) 170. The peripheral device control circuit 110 is utilized for controlling operation of the peripheral device 130, and peripheral device control circuit 110 comprises an embedded micro processor 112. The host control circuit 120 is coupled to the peripheral device control circuit 110 via the transmission interface 140, wherein the peripheral device control circuit 110 and the host control circuit 120 are disposed on the motherboard 150. In addition, the host control circuit 120 comprises: a storage module 122 and a control module 160. There is a basic input/output system (BIOS) image file (not shown) stored in the storage module 122. There is a firmware (not shown) of the embedded micro processor 112 stored in the EEPROM 170. For example, when the host system 100 is a computer host, the host control circuit 120 can comprise a CPU, a chip set, a redundant array of independent disks (RAID) host controller, and the peripheral device control circuit 110 can be a RAID chip such as a serial advanced technology attachment (SATA) RAID chip, and the transmission interface 140 can be a SATA transmission wire, and the peripheral device 130 can be a hard discs drive. In addition, the storage module 112 can be a read only memory (ROM). However, when the firmware of the embedded micro processor 112 is required to be updated, the EEPROM 170 has to be removed, and another EEPROM storing an updated firmware has to be soldered on the motherboard 150. Thus, conventional host system 100 has bad efficiency when updating the firmware of the embedded micro processor 112. In addition, the EEPROM 170 also causes additional cost for the conventional host system 100.

### SUMMARY OF THE INVENTION

It is therefore one of the objectives of the present invention to provide a host system capable of storing a firmware of an embedded micro processor of a peripheral device control circuit of the host system without using electrically erasable programmable read only memory (EEPROM) and an operating method thereof, so as to solve the above problems.

In accordance with an embodiment of the present invention, a host system is disclosed. The host system comprises:

a peripheral device control circuit, for controlling operation of at least a peripheral device, the peripheral device comprising an embedded micro processor; and

a host control circuit, coupled to the peripheral device control circuit via a transmission interface, the host control circuit comprising:

a storage module, at least storing a firmware of the embedded micro processor; and

a control module, coupled to the storage module, for controlling operation of the host control circuit, and the control module transmitting the firmware to the peripheral device control circuit via the transmission interface;

wherein the embedded micro processor executes the firmware provided by the host control circuit to control operation of the peripheral device control circuit.

In accordance with an embodiment of the present invention, an operating method for a host system is disclosed. The host system comprises: a peripheral device control circuit, for controlling operation of at least a peripheral device, the peripheral device comprising an embedded micro processor; and a host control circuit, coupled to the peripheral device control circuit via a transmission interface, the host control circuit comprising: a storage module, and a control module, coupled to the storage module, for controlling operation of the host control circuit. The operating method comprises:

storing a firmware of the embedded micro processor in the storage module;

utilizing the control module to transmit the firmware to the peripheral device control circuit via the transmission interface; and

utilizing the embedded micro processor to execute the firmware provided by the host control circuit to control operation of the peripheral device control circuit.

Briefly summarized, the host system and the operating method thereof disclosed by the present invention are capable of leaving out the EEPROM for storing the firmware of the embedded micro processor in the prior art, and thus the host system and the operating method thereof disclosed by the present invention can reduce cost and improve efficiency when updating the firmware.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional host system.

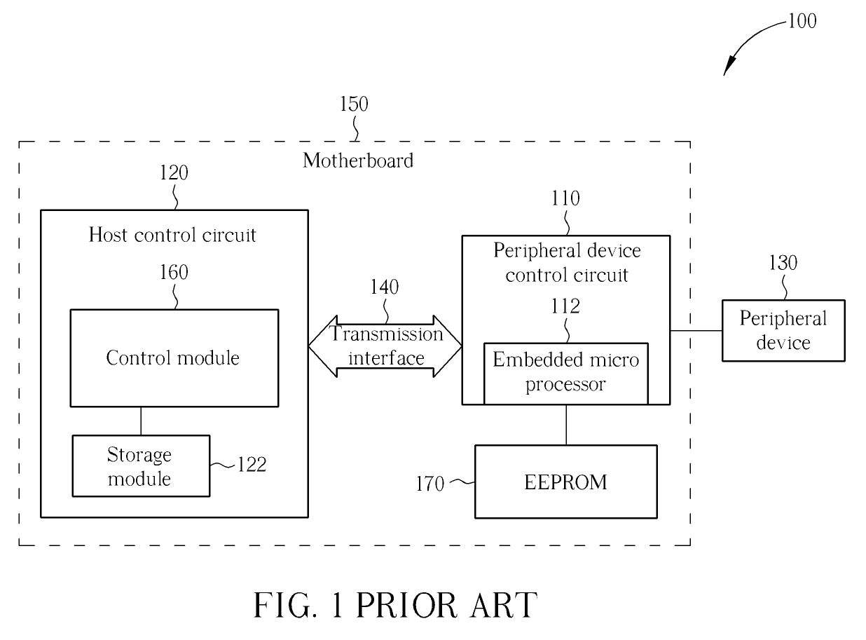

FIG. 2 shows a simplified block diagram of a host system in accordance with an embodiment of the present invention.

FIG. 3 is a flowchart showing an operating method applied to the host system in accordance with an embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . . ” The terms “couple” and “coupled” are intended to mean either an indirect or a direct electrical connection. Thus, if a first device couples to a second device, that connection may be through a direct electrical connection, or through an indirect electrical connection via other devices and connections.

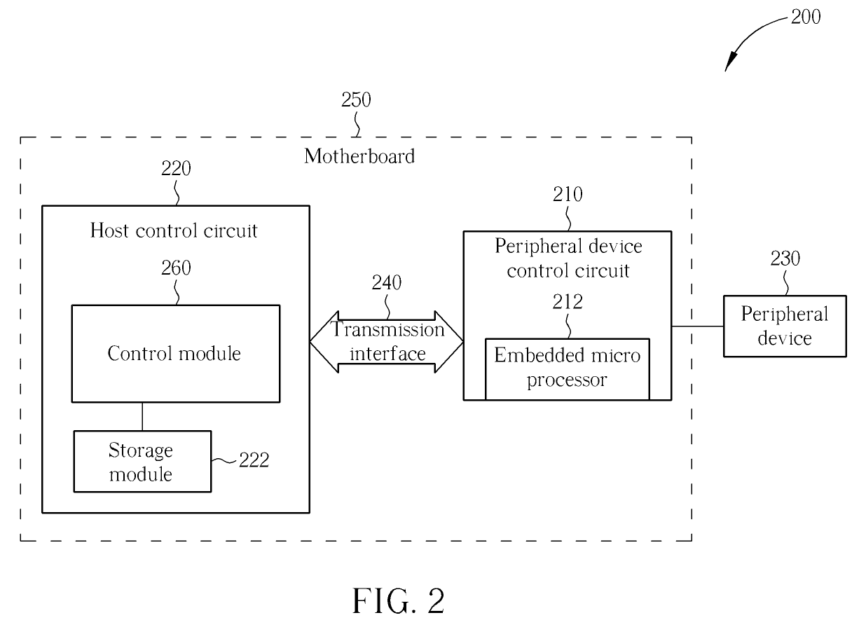

Please refer to FIG. 2. FIG. 2 shows a simplified block diagram of a host system 200 in accordance with an embodiment of the present invention. As shown in FIG. 2, the host system 200 comprises: a peripheral device control circuit 210, a host control circuit 220, a peripheral device 230, a transmission interface 240, and a motherboard 250. The peripheral device control circuit 210 is utilized for controlling operation of the peripheral device 230, and the peripheral device control circuit 210 comprises an embedded micro processor 212. The host control circuit 220 is coupled to the peripheral device control circuit 210 via the transmission interface 240, wherein the peripheral device control circuit 210 and the host control circuit 220 are disposed on the motherboard 250. In addition, the host control circuit 220 comprises: a storage module 222 and a control module 260. There are a firmware (not shown) of the embedded micro processor 212 and a basic input/output system (BIOS) image file (not shown) stored in the storage module 222, and the firmware is integrated in the BIOS image file. In other words, the firmware can be a compressed image file. The control module 260 is coupled to the storage module 222, and utilized for controlling operation of the host control circuit 220, and the control module 260 transmits the firmware to the peripheral device control circuit 210 via the transmission interface 240. More specifically, when the firmware is a compressed image file, the control module 260 reads the compressed image file from the storage module 222, and extracts the compressed image file to generate the firmware to the peripheral device control circuit 210. In addition, the embedded micro processor 212 executes the firmware provided by the host control circuit 220 to control operation of the peripheral device control circuit 210.

For example, when the host system 200 is a computer host, the host control circuit 220 can comprise a CPU, a chip set, a redundant array of independent disks (RAID) host controller, and the peripheral device control circuit 210 can be a RAID chip such as a serial advanced technology attachment (SATA) RAID chip, and the transmission interface 240 can be a SATA transmission wire, and the peripheral device 230 can be a hard discs drive. In addition, the storage module 222 can be a read only memory (ROM). In general, the control module 260 will transmit the firmware to the peripheral device control circuit 210 via the transmission interface 240 when the host system 200 executes a power-on self test (POST). On the other hand, the control module 260 also can transmit the firmware to the peripheral device control circuit 210 via the transmission interface 240 when the host system 200 recovers from a standby power management status. Since the firmware required by the embedded micro processor 212 controlling the peripheral device control circuit 210 is provided by the host control circuit 220, the host system 200 disclosed by the present invention is capable of leaving out the electrically erasable programmable read only memory (EEPROM) for storing the firmware of the embedded micro processor 212 in the prior art.

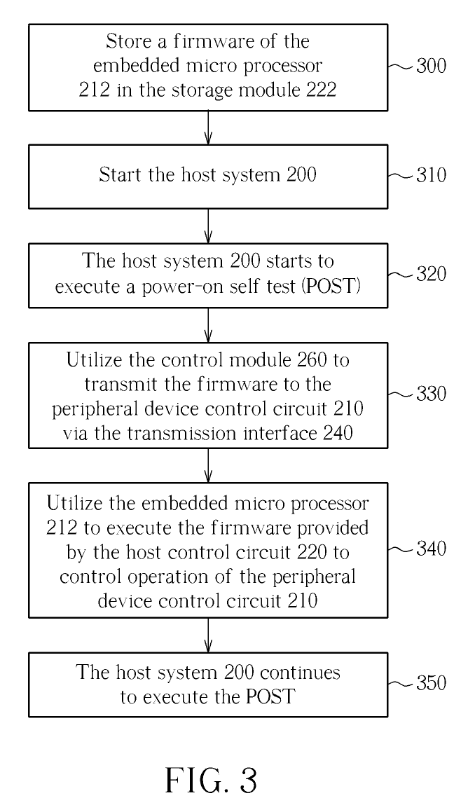

Please refer to FIG. 3. FIG. 3 is a flowchart showing an operating method applied to the host system 200 in accordance with an embodiment of the present invention. Provided that substantially the same result is achieved, the steps of the process flowchart need not be in the exact order shown in FIG. 3 and need not be contiguous, that is, other steps can be intermediate. The operating method applied to the host system 200 according to the present invention comprises the following steps:

Step 300: Store a firmware of the embedded micro processor 212 in the storage module 222.

Step 310: Start the host system 200.

Step 320: The host system 200 starts to execute a power-on self test (POST).

Step 330: Utilize the control module 260 to transmit the firmware to the peripheral device control circuit 210 via the transmission interface 240.

Step 340: Utilize the embedded micro processor 212 to execute the firmware provided by the host control circuit 220 to control operation of the peripheral device control circuit 210.

Step 350: The host system 200 continues to execute the POST.

The step of storing the firmware of the embedded micro processor 212 in the storage module 222 can comprise: integrating the firmware in a BIOS image file of the storage module 222. Next, since and the firmware integrated in the BIOS image file is a compressed image file, the step of utilizing the control module 260 to transmit the firmware to the peripheral device control circuit 210 via the transmission interface 240 can comprise: utilizing the control module 260 to read the compressed image file from the storage module 222, and extract the compressed image file to generate the firmware to the peripheral device control circuit 210. In addition, in another embodiment, when a firmware of the embedded micro processor 212 has already been stored in the storage module 222, and the host system 200 has already been started, the operating method applied to the host system 200 according to the present invention also can utilize the control module 260 to transmit the firmware to the peripheral device control circuit 210 via the transmission interface 240 when the host system 200 recovers from a standby power management status. In addition, the operating method applied to the host system 200 according to the present invention also can utilize a BIOS flash update tool to update the firmware integrated in the BIOS image file.

Briefly summarized, the host system and the operating method thereof disclosed by the present invention are capable of leaving out the EEPROM for storing the firmware of the embedded micro processor in the prior art, and thus the host system and the operating method thereof disclosed by the present invention can reduce cost and improve efficiency when updating the firmware.

Those skilled in the art will readily observe that numerous modifications and alterations of the device and method may be made while retaining the teachings of the invention.

What is claimed is:

1. A host system, comprising:
a peripheral device control circuit, for controlling operation of at least a peripheral device, the peripheral device comprising an embedded micro processor; and
a host control circuit, coupled to the peripheral device control circuit via a transmission interface, the host control circuit comprising:
a storage module, at least storing a firmware of the embedded micro processor; and
a control module, coupled to the storage module, for controlling operation of the host control circuit, and the control module transmitting the firmware to the peripheral device control circuit via the transmission interface;
wherein the embedded micro processor executes the firmware provided by the host control circuit to control operation of the peripheral device control circuit.

2. The host system of claim 1, further comprising a motherboard, and the peripheral device control circuit and the host control circuit are disposed on the motherboard.

3. The host system of claim 1, wherein the peripheral device control circuit is a redundant array of independent disks (RAID) chip.

4. The host system of claim 1, wherein the RAID chip is a serial advanced technology attachment (SATA) RAID chip.

5. The host system of claim 1, wherein the storage module stores a basic input/output system (BIOS) image file, and the firmware is integrated in the BIOS image file.

6. The host system of claim 5, wherein the firmware integrated in the BIOS image file is a compressed image file, and the control module reads the compressed image file from the storage module, and extracts the compressed image file to generate the firmware to the peripheral device control circuit.

7. The host system of claim 1, wherein the firmware required by the embedded micro processor controlling the peripheral device control circuit is provided by the host control circuit.

8. The host system of claim 1, wherein the control module transmits the firmware to the peripheral device control circuit via the transmission interface when the host system executes a power-on self test (POST).

9. The host system of claim 8, wherein the control module transmits the firmware to the peripheral device control circuit via the transmission interface when the host system recovers from a standby power management status.

10. An operating method for a host system, the host system comprising: a peripheral device control circuit, for controlling operation of at least a peripheral device, the peripheral device comprising an embedded micro processor; and a host control circuit, coupled to the peripheral device control circuit via a transmission interface, the host control circuit comprising: a storage module, and a control module, coupled to the storage module, for controlling operation of the host control circuit, the operating method comprising:
storing a firmware of the embedded micro processor in the storage module;
utilizing the control module to transmit the firmware to the peripheral device control circuit via the transmission interface; and
utilizing the embedded micro processor to execute the firmware provided by the host control circuit to control operation of the peripheral device control circuit.

11. The operating method of claim 10, wherein the host system further comprises a motherboard, and the peripheral device control circuit and the host control circuit are disposed on the motherboard.

12. The operating method of claim 10, wherein the peripheral device control circuit is a redundant array of independent disks (RAID) chip.

13. The operating method of claim 12, wherein the RAID chip is a serial advanced technology attachment (SATA) RAID chip.

14. The operating method of claim 10, wherein the storage module stores a basic input/output system (BIOS) image file, and the firmware is integrated in the BIOS image file.

15. The operating method of claim 14, wherein the firmware integrated in the BIOS image file is a compressed image file, and the step of utilizing the control module to transmit the firmware to the peripheral device control circuit via the transmission interface comprises:
utilizing the control module to read the compressed image file from the storage module, and extract the compressed image file to generate the firmware to the peripheral device control circuit.

16. The operating method of claim 10, wherein the firmware required by the embedded micro processor controlling the peripheral device control circuit is provided by the host control circuit.

17. The operating method of claim 10, wherein the step of utilizing the control module to transmit the firmware to the peripheral device control circuit via the transmission interface comprises:
utilizing the control module to transmit the firmware to the peripheral device control circuit via the transmission interface when the host system executes a power-on self test (POST).

18. The operating method of claim 17, wherein the step of utilizing the control module to transmit the firmware to the peripheral device control circuit via the transmission interface comprises:
utilizing the control module to transmit the firmware to the peripheral device control circuit via the transmission interface when the host system recovers from a standby power management status.
